(19) United States
(12) Patent Application Publication
(10) Pub. No.: US 2010/0327470 A1
(43) Pub. Date: Dec. 30, 2010

(54) PROCESS AND APPARATUS FOR PRODUCING THICK-WALLED PLASTIC COMPONENTS

(75) Inventors: Rainer Protte, Dormagen (DE); Christoph Klinkenberg, Koln (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/823,285

(22) Filed: Jun. 25, 2010

(30) Foreign Application Priority Data
Jun. 27, 2009 (DE) 102009030782.6

(51) Int. Cl. B29D 11/00; B29C 45/00; B29C 45/72; B29C 35/08; B29C 45/76

(52) U.S. Cl. 264/1.24; 264/328.15; 264/1.1; 264/402; 425/160

(57) ABSTRACT

The invention relates to a process for producing plastic components, in particular optical lenses or optical light-guides, wherein plastic melt is injected via a sprue (3, 4, 6, 8) into a cavity (1) of a moulding tool shaping the component and additional plastic melt is after-pressed into the cavity (1) for the purpose of compensating a volume contraction of the injected plastic melt due to cooling. The process is characterised in that the plastic melt located in the sprue (3, 4, 6, 8) is kept flowable by means of energy introduced in the region of the sprue until such time as the molten core of the plastic component has solidified in the course of the after-pressing of plastic melt for the purpose of compensating the volume contraction due to cooling (holding-pressure). The invention further relates to an apparatus for implementing the process.

### RELATED APPLICATIONS

This application claims benefit to German Patent Application No, 10 2009 030 782.6, filed Jun. 27, 2009, which is incorporated herein by reference in its entirety for all useful purposes.

### BACKGROUND OF THE INVENTION

The invention relates to a process for producing plastic components—in particular, optical lenses, optical light-guides and other optical components—wherein plastic melt is injected via a sprue into a cavity of a moulding tool shaping the component and additional plastic melt is pressed into the cavity for the purpose of compensating a volume contraction of the injected plastic melt due to cooling (holding pressure). In this connection the gate may be situated on a narrow side wall of the component. The invention further relates to an apparatus for injection moulding or injection-compression moulding of such plastic components, with a cavity for shaping the plastic component to be produced and with a supply device, for example an injection-moulding screw, for supplying plastic melt into the cavity via a sprue.

Particularly in the case of the injection moulding of thick-walled plastic components, such as optical components for instance, in respect of which very stringent demands are made as regards geometrical accuracy, it is necessary to compensate effectively the shrinkage of the moulding occurring ordinarily in the cavity by packing of plastic melt via holding pressure. If in the process the sprue or the region on the component close to the sprue is sealed as a result of solidification of the plastic melt (sealing-time) before the volume contraction of the component during the cooling phase has been fully concluded, this can result in sink marks, voids or warpage. In order to prevent this, in conventional manner the sprue is dimensioned in its cross-section to be as large as possible. On the other hand, however, in the case of the separation of the sprue from the component relatively large or thick sprue marks are disadvantageous, because quality-reducing eruptions of material or separation marks may arise in this case. Contaminations by dust, chips or the like may also arise in this case, which is unacceptable, for instance, in the case of clean-room conditions which are frequently demanded. Often large gates are not possible at all, because the component offers no space for this. This applies, in particular, to lenses and optical lightguides, since in components of such a type only a few surfaces are not utilised optically. In such components the sprue is ordinarily positioned on the side wall, and its minimal diameter amounts to about ⅔ of the part's maximal wall thickness. In addition, in the case of optical components many regions that are theoretically usable for the placement of a gate often fall out of consideration for aesthetic reasons, by reason of the transparent material. Furthermore, thick sprues give rise, as a rule, to additional costs as a result of a reworking of the gate mark (separation mark). In addition, relatively large or thick sprues give rise to an increased consumption of material.

It is known to subject injection-moulding tools for producing plastic objects to ultrasonic oscillations. For example, in the publication entitled “Vielseitig anwendbarer Ultraschall” by Peter Bloss et al., Kunststoffe June 2006, Carl Hanser Verlag, Munich, a positive advantage is described for the moulding of microstructures and the filling of very small cavities. The basis of these ideas is always an increase in the flowability of the plastic melt. The invention described in the following is, on the one hand, based not on the increase in the flowability of the melt—that is to say, on the lowering of the viscosity—but on a targeted avoidance of solidification. On the other hand, the introduction of the ultrasound takes place not only in the filling phase but also in the holding-pressure phase.

In U.S. Pat. No. 6,464,485 B1 an injection-moulding tool provided with a sonotrode is described which serves for producing an optical disc, for example a CD-ROM. The injection-moulding tool comprises two tool halves which together delimit a cavity shaping the optical disc, with an embossing disc for shaping structural elements being arranged on the bottom of one of the two tool halves. On the other tool half there is arranged, centrically in relation to the disc-shaped cavity, the gate for the plastic melt, whereas the input coupling of the ultrasonic oscillations is effected via the opposite tool half, substantially in undirected manner. In both tool halves annular slots or several slots arranged on an annulus are formed outside the cavity, in order to minimise the amplitude of the ultrasonic oscillations in the radial direction of the cavity.

The object underlying the present invention is to specify a process and also an apparatus with which relatively thick-walled plastic components, in particular optical lenses and optical light-guides, can be produced in inexpensive manner with very high geometrical accuracy by injection moulding or injection-compression moulding.

This object is achieved by the process according to the invention with the features described below and by the apparatus according to the invention with the features described below.

### EMBODIMENTS OF THE INVENTION

An embodiment of the present invention is a process for producing a plastic component, comprising injecting plastic melt via a sprue (3, 4, 6, 8) into a cavity (1) of a moulding tool that shapes said plastic component and packing additional plastic melt into said cavity via holding pressure (1) for the purpose of compensating for a volume contraction of the injected plastic melt due to cooling, wherein said plastic melt located in said sprue (3, 4, 6, 8) is kept flowable by means of energy introduced in the region of said sprue for such time until the solidification of any molten plastic in the core of said plastic component.

Another embodiment of the present invention is the above process, wherein said plastic component is an optical lense or an optical lightguide.

Another embodiment of the present invention is the above process, wherein said energy is introduced by means of emission of ultrasonic waves directed onto said sprue.

Another embodiment of the present invention is the above process, wherein said energy is introduced by means of a heating device.

Another embodiment of the present invention is the above process, wherein said energy is introduced by means of a combination of emission of ultrasonic waves directed onto said sprue and a heating device.

Another embodiment of the present invention is the above process, wherein said moulding tool is an injection-moulding or injection-compression-moulding tool, wherein at least one gate (8) is situated on a side wall of the plastic component to be produced, and wherein the diameter of said sprue (3, 4, 6) or of said gate (8) is less than 50% of the maximal wall thickness (9) of the plastic component.

Another embodiment of the present invention is the above process, wherein said diameter is less than 35% of the maximal wall thickness (9) of said plastic component.

Another embodiment of the present invention is the above process, wherein said diameter is less than 20% of the maximal wall thickness (9) of said plastic component.

Another embodiment of the present invention is the above process, wherein said plastic component is injection-moulded or injection-compression-moulded from one or more synthetic materials selected from the group consisting of polycarbonate, copolycarbonate, thermoplastic polyurethane, cycloolefin copolymer, cycloolefin polymer, polyamide, styrene-acrylonitrile plastic, polystyrene, poly-N-methyl methacrylimide, polymethacrylic acid ester, polymethacrylic methylimide and polyacrylate, and mixtures thereof.

Another embodiment of the present invention is the above process, wherein said plastic component is injection-moulded or injection-compression-moulded from polymethyl methacrylate.

Yet another embodiment of the present invention is an optical component prepared by the above process.

Another embodiment of the present invention is the above optical component, wherein said optical component is an optical lense or an optical light-guide.

Yet another embodiment of the present invention is an apparatus for the injection moulding or injection-compression moulding of a plastic component, wherein said apparatus comprises a cavity (1) for shaping the plastic component to be produced and a supply device for supplying plastic melt into said cavity (1) via a sprue (3, 4, 6, 8), wherein at least one sonotrode and/or at least one heating device which emits ultrasonic waves and/or heat directed onto said sprue (3, 4, 6, 8) is assigned to the sprue (3, 4, 6, 8), so that plastic melt located in said sprue (3, 4, 6, 8) is capable of being kept flowable for such time until the solidification of any molten plastic in the core of said plastic component, whereby a controller activating said sonotrode and/or heating device is present and which registers the flowability of the melt by means of a sensor and/or which includes an adjustable timing element, by means of which an activation period of the sonotrode or of the heating device is capable of being preset.

Another embodiment of the present invention is the above apparatus, wherein said plastic component is an optical lense or an optical light-guide.

Another embodiment of the present invention is the above apparatus, wherein said sprue is designed in such a way that at least one gate (8), at which the sprue leads into the cavity (1), is situated on a narrow side (9) of the plastic component to be produced, wherein the diameter of said at least one gate (8) is less than 50% of the maximal wall thickness (9) of the plastic component.

Another embodiment of the present invention is the above apparatus, wherein said diameter is less than 35% of the maximal wall thickness (9) of the plastic component.

Another embodiment of the present invention is the above apparatus, wherein at least one sonotrode which emits ultrasonic waves directed onto the gate (8) is assigned to the gate (8) at which the sprue (3, 4, 6) leads into the cavity (1).

Another embodiment of the present invention is the above apparatus, further comprising a sprue bushing (2), wherein a sonotrode for introducing ultrasound is assigned to said sprue bushing (2).

Another embodiment of the present invention is the above apparatus, further comprising a sprue bushing (2), wherein a sonotrode is integrated within said sprue bushing (2).

Another embodiment of the present invention is the above apparatus, further comprising a runner or cold runner (6), wherein a sonotrode is integrated within said runner or cold runner (6).

Another embodiment of the present invention is the above apparatus, further comprising a runner or cold runner (6), wherein a sonotrode for introducing ultrasound is assigned to said runner or cold runner (6).

Another embodiment of the present invention is the above apparatus, wherein the plastic melt located in the sprue is kept flowable solely or additionally by virtue of energy introduced in the region of said sprue by means of one or more heating devices.

### DESCRIPTION OF THE INVENTION

In the process according to the invention, plastic melt is injected into a cavity of an injection-moulding tool or injection-compression-moulding tool shaping the component. The process is characterised in that the plastic melt located in the sprue is kept flowable by energy introduced in the region of the sprue, in particular by means of emission of ultrasonic waves directed onto the sprue, until such time as the molten core of the plastic component has solidified.

By the term ‘sprue’ in the present context, the so-called gate mark (gate) between a runner or cold runner and the cavity shaping the plastic component as well as bottlenecks on the component itself are also understood where appropriate.

With the process according to the invention, in particular optical components consisting of plastic can be produced inexpensively with very high geometrical accuracy. For with the process according to the invention the shrinkage of the moulding occurring ordinarily in the cavity can be compensated effectively by after-pressing of plastic melt also in the case of a relatively small cross-sectional area of the sprue, so that plastic components of very high quality are obtained. Through a diminution of the diameter or, to be more exact, the cross-sectional area of the sprue or gate, quality-reducing eruptions of material or separation marks can be distinctly reduced. A reworking of the gate mark is then usually no longer required. The diminution of the sprue or gate offers, in addition, the possibility of placing the sprue or gate in a region of the component to be produced that, for reasons of space, could not hitherto be utilised for this. Accordingly, the sprue or gate can now be provided, for example, on a narrow side or bottleneck of the component.

A minimising of the diameter or cross-sectional area of the sprue does normally increase the tendency for the sprue to freeze up before the component to be produced has solidified, so that, inter alia, voids and sink marks due to shrinkage may occur; however, by virtue of the introduction, according to the invention, of energy into the sprue, for example by emission of directed ultrasonic waves onto the sprue, the plastic melt is kept flowable there for a sufficiently long time, so that despite a preferably relatively small or thin sprue a follow-up of plastic melt for the purpose of compensating the volume shrinkage due to cooling, which is typical of synthetic material, is guaranteed for as long as possible. Moreover, the diminution of the diameter or cross-sectional area of the sprue reduces the consumption of synthetic material.

As an alternative to introduction by means of an ultrasonic sonotrode, the introduction of energy into the sprue can also be effected via introduction of heat by means of a heating device, and/or by a combination of introduction of ultrasound and of heat.

The process according to the invention can be advantageously employed for injection moulding or injection-compression moulding of thick-walled components, for example of optical components with a wall thickness within the range from 10 mm to 20 mm, but also with other wall thicknesses. The plastic melt that is used in this connection is formed from transparent or translucent plastic. In principle, in the process according to the invention all synthetic materials that can be utilised for optical components can be used for the purpose of forming the plastic melt. The plastic melt that is used preferably consists of polycarbonate, copolycarbonate, thermoplastic polyurethane, cycloolefin copolymer, cycloolefin polymer, polyamide, styrene-acrylonitrile plastic, polystyrene, poly-N-methyl methacrylimide, polymethacrylic acid ester, polymethacrylic methylimide, or polyacrylate, in particular polymethyl methacrylate, and/or blends of these synthetic materials. Particularly preferred are polycarbonate, copolycarbonate, thermoplastic polyurethane and also blends that contain these synthetic materials.

An advantageous configuration of the process according to the invention is characterised in that the plastic that is located in the sprue by reason of the production of the plastic component has been removed from the sprue prior to the injecting of plastic melt for the purpose of producing a further plastic component. The plastic melt that was subjected to ultrasound and/or heat in the course of the previous shot has consequently been demoulded from the sprue, so that it is not injected into the cavity in the course of the following shot. By this means, a particularly high quality of the plastic components that are produced can be guaranteed; effects of the ultrasound and/or of the heat on the melt do not have a disadvantageous effect on the quality of the component. Especially in comparison with tool concepts with a hot runner this is an advantage, since in that case, especially with long cycle times, the melt has a tendency to decompose. Furthermore, in hot-runner systems there is always the risk of dead corners in which material can collect and black specks and the like can foam.

The apparatus according to the invention for injection moulding or injection-compression moulding of plastic components, in particular optical lenses or optical lightguides, includes a cavity for shaping the plastic component to be produced and a supply device, for example an injection-moulding screw, for supplying plastic melt into the cavity via a sprue. The apparatus is characterised in that at least one sonotrode and/or one heating device which emits ultrasonic waves or thermal energy directed onto the sprue is assigned to the sprue, so that the plastic melt located in the sprue is capable of being kept flowable until such time as the molten core of the plastic component has solidified in the course of the after-pressing of plastic melt for the purpose of compensating a volume contraction, due to cooling, of plastic melt located in the cavity.

In one embodiment, the apparatus includes an activating controller which registers the flowability of the melt by means of a sensor, and/or which includes an adjustable timing element, by means of which an activation period of the sonotrode or of the heating device is capable of being preset.

In the case of the heating device it is a question, for example, of an electric heater, for example an induction heater and/or ceramic heater, and/or a laser heater and/or a resistance heater.

In particular, via the process according to the invention it is possible for thick-walled plastic components, such as optical lenses for example, to be produced with constant or regionally differing wall thicknesses.

By virtue of the process according to the invention it is possible to realise sprue diameters of less than 50%, in particular less than 35%, and in special exemplary embodiments even less than 20%. Hence the sprue diameter of about ⅔ of the maximal wall thickness, which is customary in such components and predetermined by the state of the art, can be distinctly reduced.

Preferred and advantageous configurations of the process according to the invention and also of the apparatus according to the invention are specified in the dependent claims.

The invention will be elucidated in more detail in the following on the basis of a drawing representing an exemplary embodiment. Shown are:

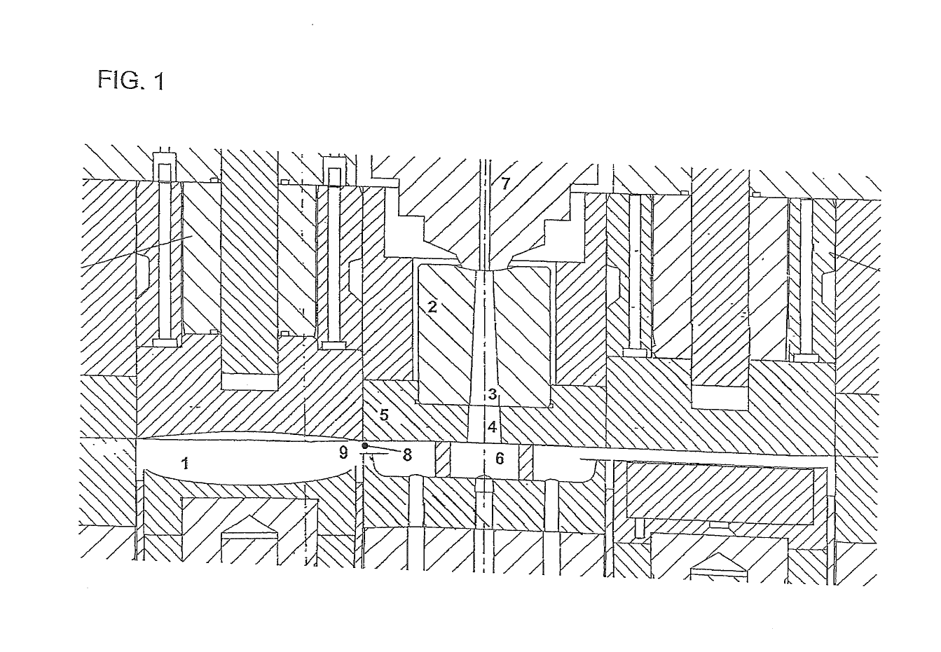

FIG. 1 a sectional view of a portion of an injection-moulding tool exhibiting a runner, in the closed state; and

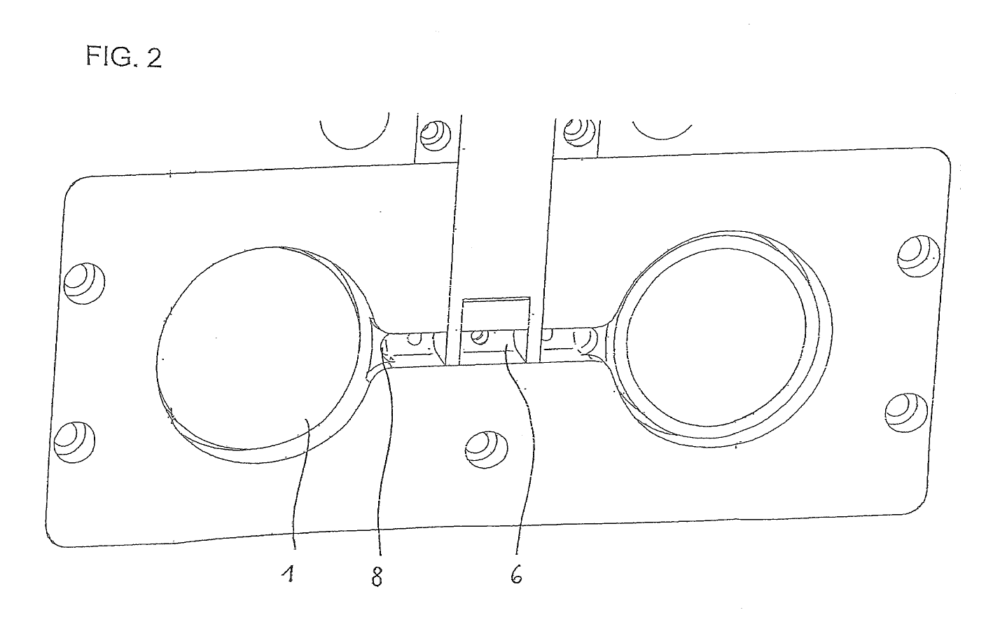

FIG. 2 a perspective top view of the open cavity of the injection-moulding tool shown in FIG. 1.

The injection-moulding tool represented in the drawing serves for producing transparent components, specifically optical lenses, from synthetic material. The injection-moulding tool consists of several components which delimit a cavity 1 shaping the component to be produced.

In the exemplary embodiment represented, the injection-moulding tool includes a sprue bushing 2 which exhibits a conically formed channel 3. The channel 3 leads into a further channel portion 4, likewise conically formed, which penetrates a plate-shaped tool part 5 and leads into a runner 6. Via the runner 6, plastic melt which is conveyed out of a nozzle 7 of an injection-moulding machine exhibiting an injection-moulding screw or another supply device into the sprue bushing is conducted into the cavity 1. In the case of the runner 6, it is preferably a question of a cold runner.

The gate 8 for the melt is arranged at the edge of the cavity 1, so that the gate 8 is situated on the periphery and consequently on a narrow side 9 of the circular-disc-shaped plastic component. By virtue of the marginal arrangement of the gate 8 on the cavity 1 it is ensured that the optical function of the lens is not impaired by the gate. The injection-moulding tool is so dimensioned that the diameter (cross-section) of the gate 8 amounts to less than 50%, in particular less than 35%, of the maximal wall thickness of the plastic component. In the exemplary embodiment represented, the diameter of the gate 8 is such that it amounts to approximately 20%, i.e. one fifth, of the thickness of the wall 9 of the plastic component.

In order to ensure a long follow-up of plastic melt into the cavity 1 despite the comparatively small diameter of the gate 8, the plastic melt is kept flowable by targeted introduction of ultrasound and/or thermal energy.

In the case of the application of ultrasound, one or more sonotrodes are integrated into the tool in such a way that they emit directed ultrasonic waves into the plastic melt located in the sprue (3, 4, 6, 8). For example, for this purpose the runner (cold runner) 6 and/or the plate-shaped tool part 5, and preferably additionally the sprue bushing 2, is/are constructed as a sonotrode or sonotrodes.

Alternatively, ultrasound is introduced into the melt-conducting region of the runner (cold runner) 6 and preferably additionally into the melt-conducting region of the sprue bushing 2. Furthermore, an introduction into regions close to the sprue of the component itself is possible.

The directed ultrasonic waves are absorbed by the plastic melt located in the sprue (3, 4, 6, 8), as a result of which the tendency thereof to freeze up decreases. The plastic melt located on the gate 8 is kept flowable in this manner until such time as no more molten core is present in the component. The sealing-time is consequently no longer dependent on the sprue, as is the case in conventional processes, but is determined by the component itself.

In other embodiments the sonotrode or sonotrodes is/are replaced by a heating device or by a combination of sonotrode and heating device.

The apparatus according to the invention exhibits a controller activating the sonotrode and/or the heating device, which, in particular, may include a sensor that registers the flowability of the melt. The sonotrode and/or the heating device is in this case activated or deactivated in a manner depending on the sensor signal. As an alternative or in addition to this sensor, the controller may include an adjustable timing element, by means of which an activation period of the sonotrode and/or heating device is capable of being preset.

The total cycle time for producing the plastic component is not extended by application of the process according to the invention, since the sprue cools down in the remaining cooling time—that is to say, after the end of the holding-pressure phase—to a suitable demoulding temperature. By reason of the small thickness (cross-sectional area) of the sprue, after the end of the holding-pressure phase, and hence after the end of the introduction of ultrasound and/or heat, the sprue cools down relatively quickly.

The process according to the invention and the apparatus according to the invention can be employed particularly advantageously for injection moulding or injection-compression moulding of transparent optical components consisting of polycarbonates, blends thereof and also thermoplastic polyurethanes. Also, with the process according to the invention and with the apparatus according to the invention corresponding components consisting of PMMA, COC, COP, PA, PMMI, SAN and/or PS can be produced inexpensively with high geometrical accuracy. The implementation of the process according to the invention is not restricted to the aforementioned exemplary embodiments; likewise, it is not restricted to the aforementioned synthetic materials; rather, all thermoplastic, especially transparent or translucent synthetic materials and also all synthetic materials that can be utilised for optical components can be processed in accordance with the process according to the invention and in the apparatus according to the invention.

1. A process for producing a plastic component, comprising injecting plastic melt via a sprue (3, 4, 6, 8) into a cavity (1) of a moulding tool that shapes said plastic component and after-pressing additional plastic melt into said cavity (1) for the purpose of compensating for a volume contraction of the injected plastic melt due to cooling, wherein said plastic melt located in said sprue (3, 4, 6, 8) is kept flowable by means of energy introduced in the region of said sprue for such time until the solidification of any molten plastic in the core of said plastic component.

2. The process of claim 1, wherein said plastic component is an optical lense or an optical light-guide.

3. The process of claim 1, wherein said energy is introduced by means of emission of ultrasonic waves directed onto said sprue.

4. The process of claim 1, wherein said energy is introduced by means of a heating device.

5. The process of claim 1, wherein said energy is introduced by means of a combination of emission of ultrasonic waves directed onto said sprue and a heating device.

6. The process of claim 1, wherein said moulding tool is an injection-moulding or injection-compression-moulding tool, wherein at least one gate (8) is situated on a side wall of the plastic component to be produced, and wherein the diameter of said sprue (3, 4, 6) or of said gate (8) is less than 50% of the maximal wall thickness (9) of the plastic component.

7. The process of claim 1, wherein said diameter is less than 35% of the maximal wall thickness (9) of said plastic component.

8. The process of claim 1, wherein said diameter is less than 20% of the maximal wall thickness (9) of said plastic component.

9. The process of claim 1, wherein said plastic component is injection-moulded or injection-compression-moulded from one or more synthetic materials selected from the group consisting of polycarbonate, copolycarbonate, thermoplastic polyurethane, cycloolefin copolymer, cycloolefin polymer, polyamide, styrene-acrylonitrile plastic, polystyrene, poly-N-methyl methacrylimide, polymethacrylic acid ester, polymethacrylic methylimide and polyacrylate, and mixtures thereof.

10. The process of claim 9, wherein said plastic component is injection-moulded or injection-compression-moulded from polymethyl methacrylate.

11. An optical component prepared by the process of claim 1.

12. The optical component of claim 11, wherein said optical component is an optical lense or an optical light-guide.

13. An apparatus for the injection moulding or injection-compression moulding of a plastic component, wherein said apparatus comprises a cavity (1) for shaping the plastic component to be produced and a supply device for supplying plastic melt into said cavity (1) via a sprue (3, 4, 6, 8), wherein at least one sonotrode and/or at least one heating device which emits ultrasonic waves and/or heat directed onto said sprue (3, 4, 6, 8) is assigned to the sprue (3, 4, 6, 8), so that plastic melt located in said sprue (3, 4, 6, 8) is capable of being kept flowable for such time until the solidification of any molten plastic in the core of said plastic component, whereby a controller activating said sonotrode and/or heating device is present and which registers the flowability of the melt by means of a sensor and/or which includes an adjustable timing element, by means of which an activation period of the sonotrode or of the heating device is capable of being preset.

14. The apparatus of claim 13, wherein said plastic component is an optical lense or an optical light-guide.

15. The apparatus of claim 13, wherein said sprue is designed in such a way that at least one gate (8), at which the sprue leads into the cavity (1), is situated on a narrow side (9) of the plastic component to be produced, wherein the diameter of said at least one gate (8) is less than 50% of the maximal wall thickness (9) of the plastic component.

16. The apparatus of claim 15, wherein said diameter is less than 35% of the maximal wall thickness (9) of the plastic component.

17. The apparatus of claim 13, wherein at least one sonotrode which emits ultrasonic waves directed onto the gate (8) is assigned to the gate (8) at which the sprue (3, 4, 6) leads into the cavity (1).

18. The apparatus of claim 13, further comprising a sprue bushing (2), wherein a sonotrode for introducing ultrasound is assigned to said sprue bushing (2).

19. The apparatus of claim 13, further comprising a sprue bushing (2), wherein a sonotrode is integrated within said sprue bushing (2).

20. The apparatus of claim 13, further comprising a runner or cold runner (6), wherein a sonotrode is integrated within said runner or cold runner (6).

21. The apparatus of claim 13, further comprising a runner or cold runner (6), wherein a sonotrode for introducing ultrasound is assigned to said runner or cold runner (6).

22. The apparatus of claim 13, wherein the plastic melt located in the sprue is kept flowable solely or additionally by virtue of energy introduced in the region of said sprue by means of one or more heating devices.
